(19) United States
(12) Patent Application Publication
(10) Pub. No.: US 2026/0029664 A1
(43) Pub. Date: Jan. 29, 2026

(54) CONTACT LENSES WITH PVA FILM

(71) Applicant: EnChroma, Inc., Berkeley, CA (US)

(72) Inventors: Sunil K. KOOVAKKAT, Hercules, CA (US); Donald M. MCPHERSON, Oakland, CA (US); Roger William ELLICOCK, JR., Berkeley, CA (US)

(73) Assignee: EnChroma, Inc., Berkeley, CA (US)

(21) Appl. No.: 19/349,320

(22) Filed: Oct. 3, 2025

Related U.S. Application Data
(63) Continuation of application No. PCT/US2024/021151, filed on Mar. 22, 2024.
(60) Provisional application No. 63/458,028, filed on Apr. 7, 2023.

(51) Int. Cl. G02C 7/04; B29D 11/00

(52) U.S. Cl. CPC G02C 7/049; B29D 11/00125; B29D 11/00903

(57) ABSTRACT

A film with a hydrophobic water-insoluble dye embedded in polyvinyl alcohol (PVA) is disclosed. The dye is uniformly distributed throughout the film and the film has substantially no organic solvents. The film may be attached to the center of a contact lens. Such a contact lens may be used to correct or improve color vision for people with a color vision deficiency.

### CROSS REFERENCE TO RELATED APPLICATIONS

This application is a continuation of PCT Application PCT/US2024/021151 filed on Mar. 22, 2024 and titled “CONTACT LENSES WITH PVA FILM,” which claims benefit of priority to U.S. Provisional Patent Application No. 63/458,028 filed Apr. 7, 2023 and titled “Contact Lenses with PVA Film.” Both of the above applications are incorporated herein by reference in their entirety.

### FIELD OF THE INVENTION

The invention generally relates to colored contact lenses.

### BACKGROUND

Tinting contact lenses with dyes play an important role in the contact lens industry for a variety of reasons including coloring to easily identify contact lens in the saline solution (so called visibility tints), colored contact lens for cosmetic uses, for the management of frequent occurrences of migraine headaches and for creating photochromic contact lenses. Various tinting methods dispersing dye into the contact lens material. But dispersing dye in the contact lens material creates real problems of potential leaching into the eye for soft contact lenses with high water content. Another issue is that the effective dye is dispersed through the entire contact lens, not where it is specifically needed.

### SUMMARY

This specification discloses a contact lens having a lens body and a film coating a center portion of the lens body. The film may be attached to the convex face of the contact lens body. In some instances, the film has a diameter between 4 mm and 7 mm and the lens body has a diameter greater than 9 mm. The film coating the center portion of the contact lens body is made of polyvinyl alcohol (PVA) with a water-insoluble dye (or hydrophobic dye) embedded within the PVA. The film has substantially no organic solvent. The water-insoluble dye (or hydrophobic dye is uniformly distributed throughout the film. The lens body itself does not contain any water-insoluble dyes.

The water-insoluble dye (or hydrophobic dye) is embedded in PVA such that the dye does not migrate out of the film after being immersed in saline solution for 30 days. Two or more dyes may be embedded in the PVA of the film. The dyes may be narrow band dyes. The dyes may be metal complex dyes.

The dye (or dyes) in the film makes the film an optical filter having an absorption spectrum. One or more dyes in the film may be a narrow band dye having a peak absorption in the range of 560 nm to 620 nm. The film may have an absorption spectrum with an absorption peak in the 560-620 nm range with an optical density of peak absorption being greater than 1. A film with these optical qualities may be used in conjunction with a contact lens to correct or improve a wearer's color vision where the wearer has a color vision deficiency.

This specification discloses a PVA film with an embedded water-insoluble dye (or hydrophobic dye) and a method of making such a film. The method starts with providing an organic solvent that does not form an azeotropic mixture with water. For example, the organic solvent may be methanol or acetone. Then a water-insoluble dye (or hydrophobic dye) is dissolved into the organic solvent to form a dye solution. Then the dye solution is mixed with an aqueous solution of polyvinyl alcohol (PVA) to form a PVA-dye solution. Then substantially all of the organic solvent is removed from the PVA-dye solution to form an aqueous PVA-dye solution.

In certain instances, substantially removing all the organic solvent involves heating the PVA-dye solution until the PVA-dye is in a solid form. Then flowing dry nitrogen or argon gas to substantially remove all of the remaining free water. This solid form of the PVA-dye may be stored and rehydrated when needed to form an aqueous PVA-dye solution. In some instances, the aqueous PVA-dye solution has a viscosity greater than 30 mPa s.

The aqueous PVA-dye solution may be made into a film by coating the aqueous PVA-dye solution on substrate and curing the aqueous PVA-dye solution. The aqueous PVA-dye solution may also be printed or coated onto a central portion of a surface of a contact lens. After printing or coating, the aqueous PVA-dye solution on the contact lens is cured to form a PVA-dye film on the surface of a contact lens body. The contact lens body does not contain any water-insoluble dyes (or hydrophobic dyes).

### BRIEF DESCRIPTION OF THE DRAWINGS

The figures described below depict various aspects of the system and methods disclosed herein. Each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 schematically illustrates a contact lens. FIG. 1A is a cross-sectional view and FIG. 1B is a plan view.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention.

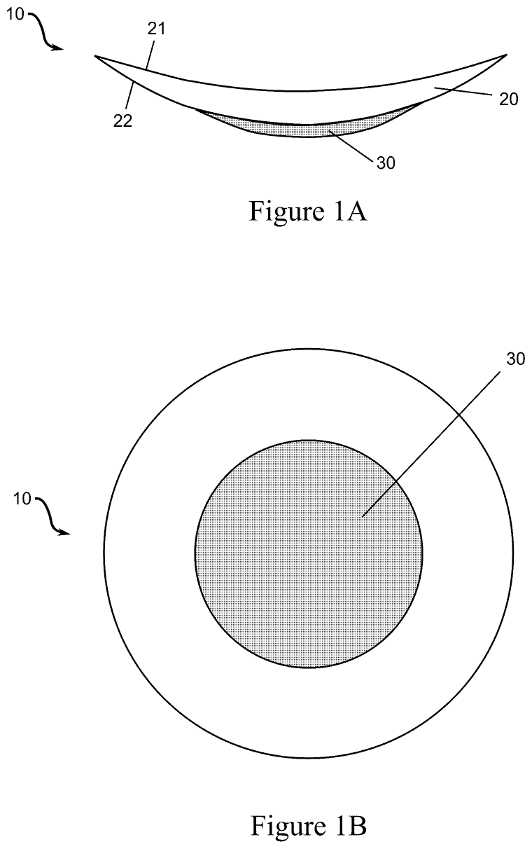

FIGS. 1A and 1B show a contact lens 10 for correcting color vision deficiencies. FIG. 1A is a cross sectional view of contact lens 10 and FIG. 1B is a plan view of contact lens 10. The lens body 20 of contact lens 10 may be a hard lens, a soft lens, an extended wear lens, or any other type of contact lens. The lens body 20 is typically bounded by a concave inner or base surface 21 and a convex outer surface 22. Generally, lens body 20 has a diameter between 13 mm and 15 mm. Preferably, the diameter of the lens body is greater than about 9 mm. Generally, the center region of the contact lens covers the pupillary region of the wearer's eye. The lens body is preferably formed of a substantially transparent, bio-compatible lens material. For example, the lens body may be formed of a polymerized hydroxyethylmethacrylate (HEMA) based lens material, e.g. Methafilcon A, or other bio-compatible transparent materials. The lens body may or may not be tinted. The lens body may or may not be configured to provide a degree of optical visual correction, i.e. the lens body may or may not provide prescription power.

Contact lens 10 also comprises a film 30 of polyvinyl alcohol (PVA) embedded with narrow band dyes. Film 30 coats the center region of the contact lens, i.e. a region that would cover the pupillary region of the wearer's eye but would preferably not extend past the iris. In some embodiments, the film has about a 6 mm diameter covering the central portion of a 13 mm to 15 mm contact lens body. The diameter of film 30 may range from 4-7 mm. FIG. 1A shows film 30 coating the convex outer surface 22 of the contact lens. Film 30 may also coat convex surface 22 of the contact lens. Film 30 has a thickness ranging from 5-25 μm, preferably about 15 μm. The molecular weight (MW) of the PVA in film 30 may range from 22,000 to 220,000 with a degree of hydrolysis (DH) of 85% to 89%.

Film 30 contains one or more dyes. These dyes are hydrophobic organic dyes that are insoluble in water. The dyes may be metal-complex dyes. The dyes may be narrow band dyes. A narrow band dye is a dye having an absorption peak with a full-width-half maximum width of at most 40 nanometers. The one or more dyes in film 30 creates an optical filter which may correct the color vision of the wearer. While film 30 contains one or more hydrophobic water-insoluble dyes, contact lens body 20 does not contain any hydrophobic water-insoluble dyes. The concentration of dyes in film 30 ranges from 100-5000 ppm. The one or more hydrophobic water-insoluble dyes are uniformly distributed throughout the film, i.e. the concentration of the dye is same throughout the film.

Having the dye uniformly distributed throughout the film is better than having the dye concentrated at the surface of the film. When dye is introduced into a film by diffusion, large concentrations of dye remain near the surface of the film with comparatively less dye at the center of the film, since diffusion relies on a concentration gradient. This type of concentration profile is disadvantageous as compared to a film with a uniform distribution of dye because dye at the surface of the film may more easily diffuse out of the film. And diffusion of dye out of the film alters the film's optical properties which is not desirable.

The dyes are stably embedded in the film 30 without any organic solvent present, such as, acetone, methanol, etc. Contact lenses with a PVA film containing water insoluble narrow band dyes may be immersed in a Phosphate Buffered Saline (PBS) solution or other similar contact lens storage solutions (“saline solution”) at room temperature for over a month (30 days) without any visible leaching of the dye into the saline solution. Further, contact lenses with a PVA film containing water insoluble narrow band dyes may be immersed in a saline solution maintained at 37 C for 14 days without any visible leaching of the dye into the saline solution. To show that the dye is fully embedded in the PVA polymer, the PVA-dye film can be dissolved in water at about 50° C. with the resulting solution having the color of the dye and with no dye precipitating in the solution because the dye is fully embedded in the PVA polymer.

The method of embedding hydrophobic water-insoluble dyes into a hydrophilic polymer such as PVA relies on first dissolving the dyes in some organic solvent, such as acetone or methanol, to create a dye solution. This dye solution in acetone or methanol can be added to a dilute solution of PVA at about 30-35° C. to produce an optically clear solution of PVA-dye-water-solvent, i.e. without precipitation of the dye or PVA from the solution. An important requirement to make this optically clear solution of PVA solution with dye is that both the dye solution and the PVA solution need to be dilute solutions. Further, organic solvent acetone or methanol are particularly useful for creating the dye solution since neither solvent forms an azeotropic mixture with water. This enables removal of substantially all the organic solvent from the dye solution. For example, substantially all of either acetone or methanol may be removed from the PVA-dye-water-solvent solution by heating at a low temperature, e.g. well below the boiling point of water. If the PVA-dye-water-solvent solution is dried on a substrate, the solvent is removed leaving behind a thin PVA-dye film. Because the film was made from a dye solution, the hydrophobic water-insoluble dyes within the film are uniformly distributed throughout the PVA film.

To remove substantially all of the acetone or methanol requires additional purifications steps. Although acetone and methanol form non-azeotropic mixtures with water, they will form hydrogen bonds with water, making removal difficult. To remove substantially all of the acetone or methanol, the water must be removed. In the first purification step, the PVA-dye-water-solvent solution is heated to around 65° C. to remove the acetone or methanol. This reduces the solvent/water ratio to some very low value. As the acetone or methanol is removed, water content will decrease proportionally (azeotropically). Reducing the water content to less than 100 ppm will reduce the acetone or methanol content to less than 1 ppm. This is possible because PVA is not soluble in acetone or methanol and since both the organic solvents have their boiling points at or near 65 C and a vapor pressure a factor of 4-5 times that of water at 65 C. A first additional purification step dries out the solution to form a solid by heating the solution to 70-75° C. This solid can be further divided to make a powder. In the second additional purification step this solid is heated at 60-85° C. in flowing dry nitrogen or argon gas to entrain and carry away substantially all of the remaining free water. The powder form of the solid will release free water at a faster rate. The water-free solid can now be stored or rehydrated. These purification steps allow for production of an aqueous solution of the PVA with the hydrophobic dyes in solution without any detectable trace of the organic solvents used in making the dye solution.

Preferably, the aqueous PVA-dye solution is printed on either onto the concave mold face of the contact lens body or convex face of a contact lens body using the technique of pad-transfer printing. The viscosity of the aqueous PVA-dye solution should be maintained within a value around 40 mPa s (millipascal seconds) to prevent the solution from running or drying unevenly, e.g. a viscosity greater than 30 mPa s. The target viscosity value can be met by removing sufficient water from the aqueous PVA-dye-water solution prior to pad-transfer printing. The PVA is printed onto a contact lens body in its unhydrated (dry) “chip” form. After printing, the aqueous PVA-dye solution is cured either by passive drying, which partially crosslinks the PVA or UV irradiation if a photo-initiator is added to the solution to fully crosslink the PVA. Curing of the aqueous PVA-dye solution on the contact lens body forms film 30 of contact lens 10.

Peak wavelength of dye absorption needs to be determined experimentally. The spectral characteristics of the dyes are affected by embedding in a PVA film: specifically, the MW and DH of the PVA polymer film affects the peak absorption maximum and the spectral line width of the dye. It is necessary to know these spectral characteristics in order to optimize the filter design.

The spectral characteristics of the dyes were measured in PVA of different MW and high DH of 98%. It was observed that the peak wavelength, strength, and full-width-at-half-maximum stabilize for MW of PVA above 60,000 and DH over 98%.

One method of correcting or enhancing color vision for color vision deficient individuals is to provide an optical filter that enhances green-red chromatic contrast. Such a filter may be made by using a narrow band dye with a peak absorption in the range of 560 nm to 620 nm. Preferably, the optical density spectra of a filter containing the narrow band dye has an optical density greater than 1 at the peak absorption wavelength of the narrow band dye. For example, a PVA-dye film may provide such an optical filter if the optical density spectra of the PVA-dye film has a peak absorption in the range of 560 nm to 620 nm and that peak absorption has an optical density greater than 1.

### Example 1

Narrow band Exciton dye ABS-574L was dissolved in methanol at a concentration of 0.12 g/l. 11.4 ml of dye solution was added to 13 g of a 4% PVA solution with degree of hydrolysis of 89% and molecular weight distributed in the range 20,000-200,000 held at 30° C. This solution was stirred at 65° C. for an hour. Thin films of the PVA-dye solutions were made on glass slides and dried. These films were of exceptional optical quality, showed maximum absorption at 576 nm in the optical spectra recorded in the range 400-700 nm, and may be used as optical filters.

### Example 2

Narrow band Exciton dye ABS-594 was dissolved in methanol at a concentration of 0.49 g/l. 10.5 ml of the dye solution was added to 8.0 g of a 4% PVA solution with degree of hydrolysis of 89% and molecular weight distributed in the range 20,000-200,000 held at 30° C. This solution was stirred at 65 C for an hour. Thin films of the PVA-dye solutions were made on glass slides and dried. These films were of exceptional optical quality, showed maximum absorption at 599 nm in the optical spectra recorded in the range 400-700 nm, and may be used as optical filters.

### Example 3

Narrow band Exciton dye ABS-594 was dissolved in acetone at a concentration of 0.49 g/l. 10.5 ml of the dye solution was added to 8.0 g of a 4% PVA solution with degree of hydrolysis of 89% and molecular weight distributed in the range 20,000-200,000 held at 30° C. This solution was stirred at 65 C for an hour. Thin films of the PVA-dye solutions were made on glass slides and dried. These films were of exceptional optical quality, showed maximum absorption at 599 nm in the optical spectra recorded in the range 400-700 nm, and may be used as optical filters.

### Example 4

Aqueous PVA-dye solution of ABS-594 (from Example 2) was coated on a contact lens body in the dry chip form at the center of the lens. The lens was then dried at room temperature in an oven. After drying, the contact lens was immersed in a saline solution for over a month. No visible leaching of dye into the saline solution occurred after a month in saline solution and the thin layer of the PVA-dye remained attached to the contact lens.

### Example 5

Aqueous PVA-dye solution of ABS-594 (from Example 2) was coated on a contact lens body (Methafilcon A) at the center of the lens. The lens was then dried at room temperature in an oven. After drying, the contact lens was immersed in a saline solution maintained at 37° C. for 14 days without any visible leaching of the dye into the saline solution and the thin layer of PVA-dye remained stable and attached to the center of the contact lens.

### Example 6

A thin film of aqueous PVA-dye solution of ABS-594 (from Example 2) was coated on a glass slide and dried at room temperature in an oven. When this PVA-dye film was immersed in water at 50° C., the PVA-dye film dissolved in water. The solution was clear and had the color of the dye, indicating that the dye was still embedded in the PVA polymer, because if the dye were not embedded in the polymer then the water insoluble dye would precipitate out of the solution and the solution would have been colorless.

### Example 7

Aqueous PVA-dye solution of ABS-594 (from Example 2) was stirred at 65° C. for an hour. Then the solution was heated to 70-75° C. until all the water was removed, and the PVA-dye became solid. The solid PVA-dye was then powdered and heated to 70-75° C. in flowing dry argon to remove all remaining water and any remaining traces of methanol. This PVA-dye solid was stored and rehydrated in water. The rehydrated PVA-dye solution had no detectable trace of methanol.

1. A contact lens comprising:
a lens body comprising a face and a center portion, the lens body containing no water-insoluble dyes; and
a film coating the center portion of the face of the lens body, the film comprising a water-insoluble dye embedded in polyvinyl alcohol (PVA), the water-insoluble dye uniformly distributed throughout the film, the film having substantially no organic solvents.

2. A contact lens comprising:
a lens body comprising a face and a center portion, the lens body containing no hydrophobic dyes; and
a film coating the center portion of the face of the lens body, the film comprising a hydrophobic dye embedded in polyvinyl alcohol (PVA), the hydrophobic dye uniformly distributed throughout the film, the film having substantially no organic solvents.

3. The contact lens of claim 2, wherein the dye is embedded in PVA such that the dye does not migrate out of the film after 30 days in saline solution.

4. The contact lens of claim 2, wherein the face is a convex face.

5. The contact lens of claim 2, wherein the film comprises two or more water-insoluble dyes.

6. The contact lens of claim 2, wherein the dye is a narrow band dye.

7. The contact lens of claim 6, wherein the narrow band dye has a peak absorption in the range of 560 nm to 620 nm.

8. The contact lens of claim 7, wherein the film is an optical filter having an absorption spectrum with an optical density greater than one at the wavelength of the peak absorption.

9. The contact lens of claim 6, wherein the dye is a metal-complex dye.

10. The contact lens according to claim 2, wherein the film has a diameter between 4 mm and 7 mm and the lens body has a diameter greater than 9 mm.

11. A method of making a contact lens, comprising:
providing an organic solvent that does not form an azeotropic mixture with water;
dissolving a water-insoluble dye in the organic solvent to form a dye solution;
mixing the dye solution with an aqueous solution of polyvinyl alcohol (PVA) to form a PVA-dye solution;
removing substantially all of the organic solvent from the PVA-dye solution to form an aqueous PVA-dye solution;
printing the aqueous PVA-dye solution onto a central portion of a surface of a contact lens; and
curing the aqueous PVA-dye solution on the contact lens to form a PVA-dye film on the surface of the contact lens.

12. The method of claim 11, wherein the organic solvent is methanol.

13. The method of claim 11, wherein the organic solvent is acetone.

14. The method of claim 11, wherein the face is a convex face.

15. The method of claim 11, wherein dissolving comprises dissolving a second water-insoluble dye in methanol or acetone.

16. The method of claim 11, wherein the water-insoluble dye is a narrow band dye.

17. The method of claim 16, wherein the water-insoluble dye is a metal-complex dye.

18. The method of claim 11, wherein printing comprises printing the aqueous PVA-dye solution onto the between 5 mm and 7 mm diameter central portion of the contact lens.

19. The method of claim 11, wherein before printing, removing water from the aqueous PVA-dye solution until the viscosity of the solution is greater than 30 mPa s.

20. The method of claim 11, wherein the curing cross links the PVA in the aqueous PVA-dye solution.
